(19) United States
(12) Patent Application Publication
(10) Pub. No.: US 2024/0211762 A1
(43) Pub. Date: Jun. 27, 2024

(54) OPTIMIZING LOW PRECISION AND SPARSITY INFERENCE WITHOUT RETRAINING

(71) Applicant: Advanced Micro Devices, Inc., Santa Clara, CA (US)

(72) Inventors: Adam H. Li, San Diego, CA (US); Eric F. Dellinger, Longmont, CO (US); Philip Bryn James-Roxby, Longmont, CO (US); Shomy Sanyal, Whitefield (IN); Benjamin Thomas Sander, Austin, TX (US); Ralph Detlef Wittig, San Jose, CA (US)

(21) Appl. No.: 18/146,828

(22) Filed: Dec. 27, 2022

(51) Int. Cl. G06N 3/082

(52) U.S. Cl. CPC G06N 3/082

(57) ABSTRACT

An apparatus and method for efficiently creating less computationally intensive nodes for a neural network. In various implementations, a computing system includes a processor and a memory with circuitry that stores multiple input data values to process during inference of a trained neural network. The processor determines, during inference, which node input values, node intermediate values, and node output values of the trained neural network to represent in a respective one of multiple available floating-point formats with less precision. No retraining is performed, but rather, the updates to the representations occur during inference. The processor uses selection criteria to reduce the amount of computation involved for updating the representations during inference while maintaining accuracy above an accuracy threshold. To do so, the processor uses the selection criteria to reduce the number of layers, the number of nodes within a layer, and the number of weight values per node to inspect.

### BACKGROUND

### Description of the Relevant Art

Neural networks are used in a variety of applications in a variety of fields such as physics, chemistry, biology, engineering, social media, finance, and so on. Some of the applications that use neural networks are text recognition, image recognition, speech recognition, blood disease and other medical conditions recognition, and so on. Neural networks use one or more layers of nodes to classify data in order to provide an output value representing a prediction when given a set of inputs. During training of the neural network, predetermined training input data is sent to the first layer of the neural network. Weight values are determined and sent to the one or more layers of the neural network. The weight values determine an amount of influence that a change in a particular input data value will have upon a particular output data value within the one or more layers of the neural network. In some designs, initial weight values are pseudo-random generated values. As training occurs, the weight values are adjusted based on comparisons of generated output values to predetermined training output values.

When training completes, a computing system uses the trained neural network to generate predicted output values. These predicted output values are based on at least the trained weight values and a new set of input data values provided in the field of use. However, the trained neural network typically uses a high number of computations to provide the predicted output values. Therefore, system cost increases to provide hardware resources that can process the relatively high number of computations in a suitable timeframe. If an organization cannot support the high cost of using the trained neural network, then the organization is unable to benefit from the trained neural network.

In view of the above, efficient methods and apparatuses for creating less computationally intensive nodes for a neural network are desired.

### BRIEF DESCRIPTION OF THE DRAWINGS

FIG. 1 is a generalized block diagram of a design timeline that illustrates steps performed over time that create less computationally intensive nodes for a neural network.

FIG. 2 is a generalized block diagram of a method for efficiently creating less computationally intensive nodes for a neural network.

FIG. 3 is a generalized block diagram of a trained neural network that includes less computationally intensive nodes.

FIG. 4 is a generalized block diagram of a neuron that includes less computationally intensive operations.

FIG. 5 is a generalized block diagram of a method for efficiently creating less computationally intensive nodes for a neural network.

FIG. 6 is a generalized block diagram of a computing system.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently creating less computationally intensive nodes for a neural network are contemplated. In various implementations, a computing system includes a memory with circuitry that stores multiple input data values to process during inference of a trained neural network. The neural network is a data model that classifies data or performs a function in order to provide an output that represents a prediction when given a set of input data values. As used herein, the term “neural network” refers to single-layer neural networks and the term can refer to deep neural networks (DNNs) with the relatively high number of hidden layers. The term “neural network” can also be used to refer to a neural network that includes an input layer, the one or more hidden layers, and the output layer where the number of hidden layers is less than the relatively high number used to classify a deep neural network (DNN). Each node of a neural network layer (or layer) combines a particular received input data value with a particular trained weight value. Typically, the nodes use matrix multiplication such as General Matrix Multiplication (GEMM) operations.

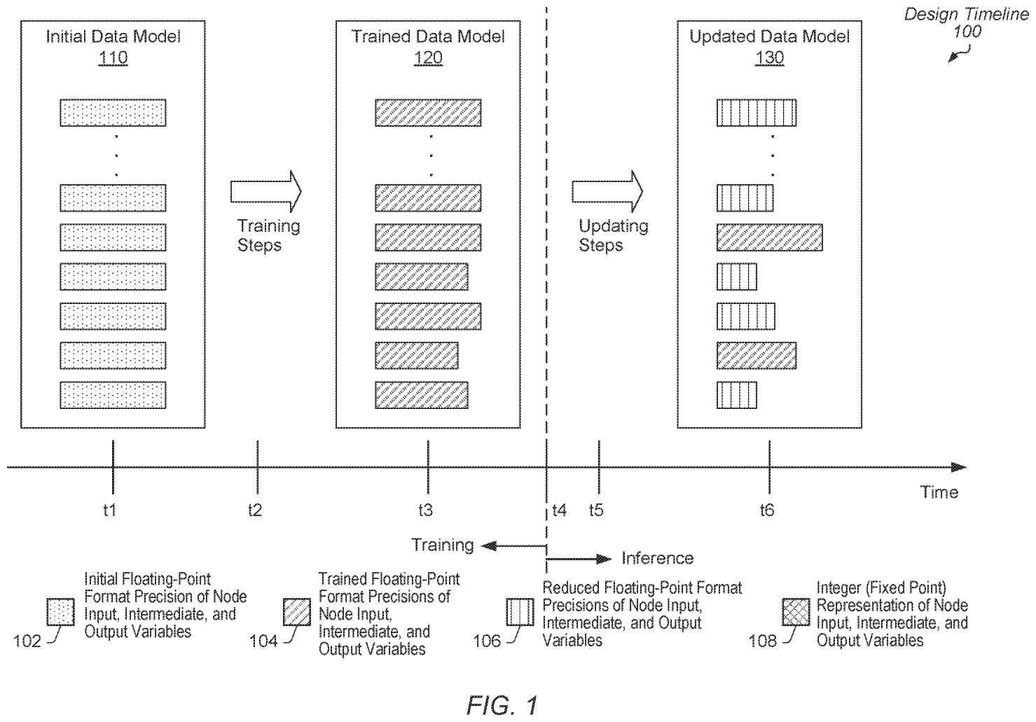

To create less computationally intensive nodes for the trained neural network used during inference, the circuitry of a processor determines, during inference, which node input values, node intermediate values, and node output values of the trained neural network to represent in a different floating-point format with less precision. No retraining is performed. The updates to the representations occur during inference. The processor uses selection criteria to reduce the number of layers and the number of nodes within a layer to inspect. The selection criteria can also be used to reduce the number of weight values per node to inspect. The selection criteria can also be used to reduce the number of available numerical formats from which to select to provide the representations. If these numbers are reduced, then a number of iterations to perform in order to determine which node input values, node intermediate values, and node output values of the trained neural network to represent in a different floating-point format with less precision is also greatly reduced. Further details of these steps to create less computationally intensive nodes for the neural network are provided in the following discussion of FIGS. 1-6.

Referring to FIG. 1, a generalized diagram is shown of a design timeline 100 that illustrates steps performed over time that create less computationally intensive nodes for a neural network. Multiple versions of a data model are shown during different points in time. The data model implements one of a variety of types of a neural network. Examples of the neural network are convolutional neural networks, recurrent neural networks, generative adversarial neural networks, and transformer neural networks. The versions of the data model are created based on training steps, and then afterward during inference by updating steps. Training steps occur prior to the point in time t4 (or time t4), whereas, updating steps during inference occur after time t4 such as to the right of the vertical dashed line. An initial data model 110 is updated by the training steps to create the trained data model 120, and then afterward the trained data model 120 is updated by steps performed during inference to create the updated data model 130.

In contrast to the training steps at time t2, the updating steps at time t5 do not change, between the trained data model 120 and the updated data model 130, the number of layers, the number of nodes for each of the layers, the number of weight values for each of the nodes, the number of non-zero bias values for each of the nodes, the actual values of the weight values and the non-zero bias values, and the interconnections between nodes of neighboring layers. Rather, the updating steps at time t5 reduces the precision of the floating-point format of one or more node input, intermediate, and output variables. In the first layer, the node input variables include the inference input data values. In other layers, the node input variables also include the trained weight values. Further details are provided in the below description.

The neural network implemented by the initial data model 110 (and trained data model 120 and updated data model 130) classifies data or performs a function in order to provide an output that represents a prediction when provided with a set of input data values. To do so, the neural network uses one or more layers of nodes (or neurons) between an input layer and an output layer of nodes. Each node has a specified activation function and one or more specified weight values that are determined during training of the neural network.

As shown, at time t1, the initial data model 110 is available. One of a variety of types of data storage (not shown) includes a copy of the initial data model 110. For example, one or more of a variety of types of hard disk drives, solid-state disks (SSDs), dynamic random-access memory (DRAM), and static random-access memory (SRAM) stores a copy of the initial data model 110. The initial data model uses the initial floating-point format precision 102 of node input, intermediate, and output variables. Each node of the multiple nodes of the initial data model 110 receives corresponding weight values of multiple initial weight values. In an implementation, a designer generates pseudo-random values for the initial weight values. In another implementations, the designer generates the initial weight values based on weight values of a similar type of another neural network.

The initial weight values are represented in the initial floating-point format precision 102. In some implementations, each of the initial floating-point formats has a same precision. In other implementations, one or more of the initial weight values are represented in a floating-point format with different precision than other ones of the initial weight values. Similar to other variables represented in the initial floating-point format precision 102, each of the initial weight values includes a corresponding mantissa and a corresponding exponent. A sum of the number of bits of the mantissa and the number of bits of the exponent equals the total data size of a particular weight value represented in a floating-point format. The precision of a floating-point number is equal to a size of the mantissa. Typically, a 32-bit floating-point format includes a mantissa with a size of 24 bits and an exponent with a size of 8 bits. Therefore, a typical 32-bit floating-point value has a precision of 24 bits.

Examples of the floating-point formats include one of a variety of 32-bit floating-point formats such as the IEEE Standard 754 32-bit floating-point (FP32) format and the Tensor Float 32-bit floating-point (TF32) format. Examples of the floating-point formats also include one of a variety of 16-bit floating-point formats such as the IEEE Standard 754 16-bit floating-point (FP16) format, the bfloat16 16-bit floating-point (BF16) format, and the block floating point (BFP) 16-bit floating-point (BFP16) format. Examples of the floating-point formats also include one of a variety of 8-bit floating-point formats such as the FP8 specification, the ms-fp8 specification, the FP8r specification and the FP8P specification. Examples of the floating-point formats do not include any integer (fixed-point) formats. Therefore, the initial weight values do not include any weight values in the integer (fixed-point) format.

At time t2, training steps are performed on the initial data model 110 to create the trained data model 120 by time t3. During training of the neural network of the initial data model 110, the initial weight values are sent to the first layer of the neural network. New, updated weight values are determined and sent on one or more nodes of a next layer of the neural network. In this next layer, new, updated weight values are determined and sent to one or more nodes of another next layer of the neural network, and this process continues until the output layer is reached. The weight values determine an amount of influence that a change in a particular input data value will have upon a particular output data value within the one or more layers of the neural network. As training occurs, the weight values are adjusted based on comparisons of generated output values to predetermined training output values. Eventually, the neural network converges, which indicates that the neural network generates output values based on particular input values with an absolute value of a difference between the generated output values and predetermined output values that is less than a difference threshold. In other words, the accuracy of the generated output values exceeds an accuracy threshold. The accuracy threshold can be indicated as a ratio and transformed into a percentage. An example of the accuracy threshold is 99.7%.

At time t3 (or prior to time t4), training of the neural network has completed. The trained data model 120 includes the trained weight values represented in the trained floating-point format precision 104 of node input, intermediate, and output variables. Hardware resources, though, used to run the trained data model 120 can become expensive. Examples of the hardware resources are semiconductor chip circuitry that executes the activation functions of the nodes of the neural network, and the data storage types used to store the amount of input data values, the trained weight values, and the output values. Additionally, the hardware resources include any networking or other interconnections used for transferring instructions and data during the execution of the trained data model 120. It is possible for the trained data model 120 to include tens of millions of input data values and trained weight values. It is also possible for the trained data model 120 to execute hundreds of millions or billions of floating-point operations to generate a prediction for a particular set of input values.

In order to reduce the demands on the hardware resources to run the trained data model 120, at time t5, updating steps are performed on the trained data model 120 to create the updated data model 130 by time t6. The updated data model 130 includes the trained weight values that includes one or more trained weight values represented in the reduced floating-point format precision 106 of node input, intermediate, and output variables with less precision than the trained floating-point format precision 104 In an implementation, one or more of the trained weight values represented in the reduced floating-point format precision 106 use a data size of 16 bits with a mantissa of 10 bits and an exponent of 6 bits, whereas, corresponding weight values in the trained floating-point format precision 104 use a data size of 32 bits with a mantissa of 24 bits and an exponent of 8 bits. Other data sizes are possible and contemplated.

It is noted that the trained weight values and other node input, intermediate and output variables represented in the reduced floating-point format precision 106 can have varying data sizes with respect to one another. Therefore, the shaded blocks representing the reduced floating-point format precision 106 have varying dimensions. Since the reduced floating-point format precision 106 is less than the trained floating-point format precision 104, the size of one or more of the shaded blocks representing the reduced floating-point format precision 106 is smaller than the size of corresponding shaded blocks representing the trained floating-point format precision 104. It is also noted that there are no retraining steps performed during the updating steps at time t4. As shown, training of the neural network occurs prior to time t4, and inference of the neural network occurs after time t4. It is also noted that, in various implementations, no node input, intermediate, and output variables use an integer (fixed-point) format 108.

Due to the significant number of computations to perform for the trained data model 120 based on the large number of layers and the number of nodes within a layer, performing the updating steps at time t4 is non-trivial. For example, it is not feasible to inspect each node of each layer of the trained data model 120 to determine whether a corresponding one of the node input, intermediate, and output variables can have its representation reduced to a smaller precision. In one implementation, the trained data model 120 has 100 layers with 20 nodes per layer. In this example, there are at least (20×20×100) node input values, which is 40,000 node input values. Increasing the number of available numerical formats from 1 to 2 causes the number of combinations of representations of the node input values to significantly increase. For example, by having all but one of the 40,000 node input values represented in a first available numerical format and only a single node input value represented in a second available numerical format, the number of combinations of representations of the node input values increases from 40,000 to (40,000×40,000), or 1.6 billion.

By having all but two of the 40,000 node input values represented in the first available numerical format and only two node input values represented in the second available numerical format, the number of combinations of representations of the node input values significantly increases beyond 1.6 billion. Continuing with having all but three and then four and then five of the 40,000 node input values represented in the first available numerical format while only three and then four and then five node input values are represented in the second available numerical format, the number of combinations of node input values continues to significantly increase. Further increasing the number of available numerical formats, such as using 5 available numerical formats instead of 2 available numerical formats, continues to significantly increase the number of combinations of representations of the node input values far past 1.6 billion. Further, the number of combinations of representations of the node intermediate values and the node output values further increase the total number of combinations to inspect to determine which values can use reduced floating-point format precision 106. To reduce the number of combinations, multiple different types of techniques can be used in the updating steps at time t4.

The hardware, such as circuitry, of an integrated circuit (not shown) performs the updating steps at time t4. When performing the updating steps, the integrated circuit uses selection criteria to reduce the number of layers and the number of nodes within a layer to inspect. The selection criteria can also be used to reduce the number of node input values, node intermediate values, and node output values per node to inspect. The selection criteria can also be used to reduce the number of available numerical formats from which to select to represent the node input values, node intermediate values, and node output values. If these numbers are reduced, then a number of iterations to perform in order to determine which ones of the node input values, node intermediate values, and node output values throughout the trained data model 120 to represent in a different, smaller floating-point format to create the updated data model 130 is also greatly reduced. Using the previous example, if the selection criteria can be used to reduce the number of layers to inspect from 100 to 12, and the number of nodes per layer to inspect from 20 to an average of 8, then a number of node input values to inspect for determining whether to update the numerical format representation reduces from (20×20×100), or 40,000 node input values to inspect, to (8×8×12), or 768 node input values to inspect. The selection criteria can also be used to reduce the number of available numerical formats, such as from 5 to an average of 3. Accordingly, a number of iterations to perform with the trained neural network during inference in order to determine which ones of the node input values, node intermediate values, and node output values throughout the trained data model 120 can be represented with a floating-point format with less precision is also reduced.

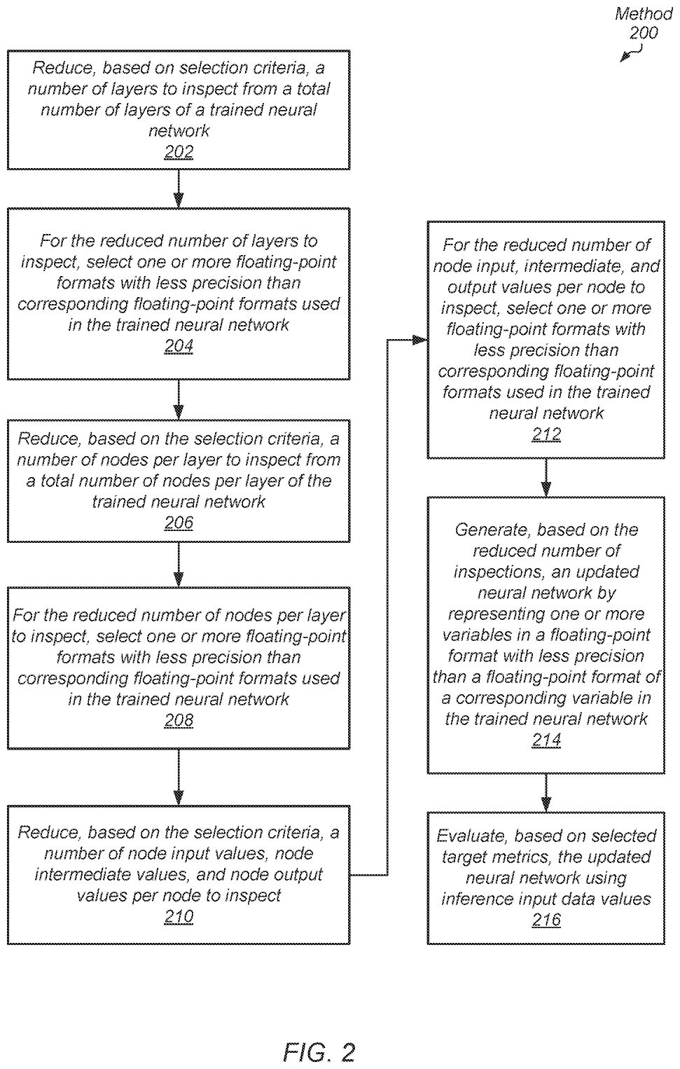

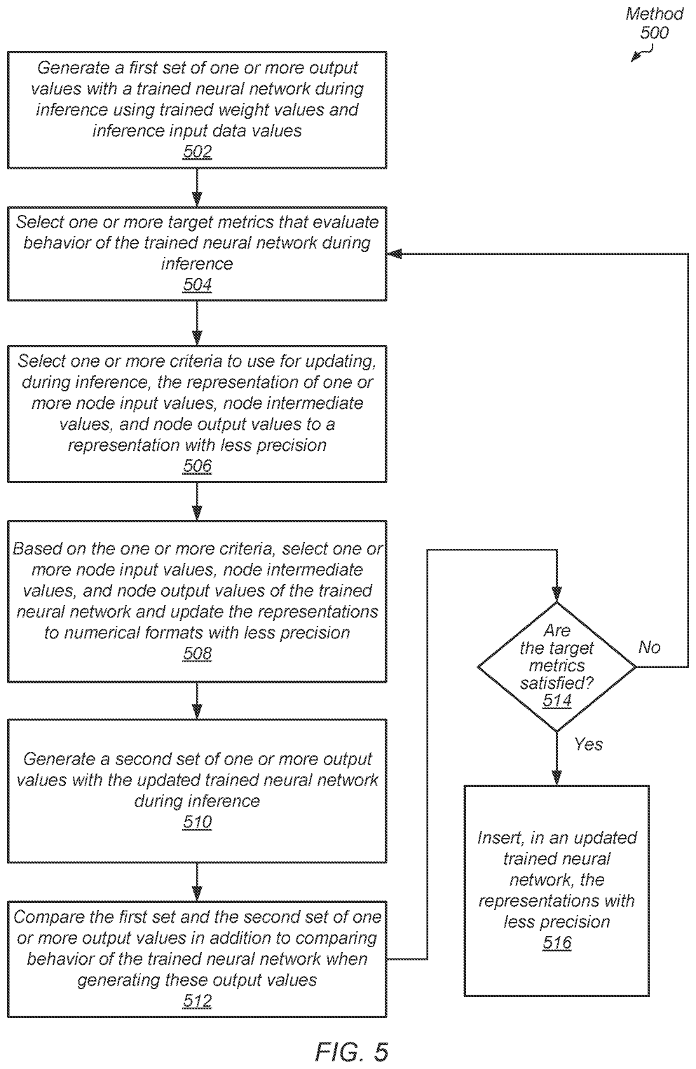

Referring to FIG. 2, a generalized block diagram is shown of a method 200 for efficiently creating less computationally intensive nodes for a neural network. For purposes of discussion, the steps in this implementation (as well as in FIG. 5) are shown in sequential order. However, in other implementations some steps occur in a different order than shown, some steps are performed concurrently, some steps are combined with other steps, and some steps are absent.

Circuitry of one of a variety of types of an integrated circuit performs steps to reduce a number of iterations to use for inspecting and updating with less precision representations of node input values, node intermediate values, and node output values throughout a trained neural network. The integrated circuit uses selection criteria to reduce a number of layers to inspect of the trained neural network (block 202). The selection criteria can include identification of the type of neural network that is the trained neural network. As described earlier, examples of the neural network of the trained neural network are convolutional neural networks, recurrent neural networks, generative adversarial neural networks, and transformer neural networks. The type of neural network can be used to determine which layers (and which nodes per layer, and which weights per node) have an influence level above an influence threshold. The influence level measures an amount of influence that changes of the layers have upon a particular output data value. Layers that do not have an influence level above the influence threshold are removed from consideration for performing the relatively high number of iterations seeking to change representations of a significant number of the trained weight values to representations with less precision.

For the reduced number of layers to inspect, the integrated circuit selects one or more floating-point formats with less precision than corresponding floating-point formats used in the trained neural network (block 204). The integrated circuit uses selection criteria to reduce a number of nodes per layer to inspect of the trained neural network (block 206). In addition to the type of neural network, the selection criteria can also include accessing a copy of statistics gathered during the training steps used to generate the trained neural network. The statistics can provide the influence level of layers in addition to providing influence levels of the nodes per layer. The statistics can also provide information such as an amount of data storage required for particular input values, and performance levels and accuracy levels of the updated trained neural network for particular input values. This information can be used to prune both the number of layers and the number of nodes per layer to inspect when determining which ones of the node input values, node intermediate values, and node output values throughout the trained neural network to consider for representing in a different floating-point format with less precision.

The selection criteria can also include user input. The user can provide input at a keyboard or other peripheral device, or the user can generate a file that is accessed by the integrated circuit to determine how to reduce the number of layers and the number of nodes per layer to inspect. The user can specify these numbers. Additionally, the user can provide identifiers of which particular layers and which particular nodes per layer to inspect.

For the reduced number of nodes per layer to inspect, the integrated circuit selects one or more floating-point formats with less precision than corresponding floating-point formats used in the trained neural network (block 208). The integrated circuit uses selection criteria to reduce a number of node input values, node intermediate values, and node output values per node to inspect of the trained neural network (block 210). In addition to the above examples of selection criteria, the selection criteria can also include statistics of the trained weight values. For example, for particular layers and particular nodes, the trained weight values can stay within a range of weight values. These statistics can indicate which weight values stay within a range that has relatively low precision, which indicates that the weight values can be represented in a floating-point format with less precision. These statistics can also indicate which weight values stay within a range that requires relatively high precision, which indicates that the weight values should be skipped during the number of iterations performed to seek to change the representation of a significant number of the trained weight values.

For the reduced number of node input values, node intermediate values, and node output values per node to inspect, the integrated circuit selects one or more floating-point formats with less precision than corresponding floating-point formats used in the trained neural network (block 212). For example, some available numerical formats can provide a precision that is deemed too low for particular layers, particular nodes of layers, and particular weight values of nodes. Therefore, these available numerical formats are removed from performing the relatively high number of iterations seeking to change the representation of one or more of the node input values, node intermediate values, and node output values throughout the trained neural network. In addition to the above examples of selection criteria, the selection criteria can also include a type of the input values provided during inference. Although the type of neural network is typically selected for particular workloads, types of the set of input values received by the trained neural network can still vary. Indications of the type of the set of input values can be used to reduce, during inspection that occurs during inference, each of the number of layers, the number of nodes per layer, the number of node input values, node intermediate values, and node output values per node, and the number of available numerical formats.

The integrated circuit generates, based on the reduced number of inspections, an updated neural network by representing one or more variables in a floating-point format with less precision than a floating-point format of a corresponding variable in the trained neural network (block 214). The integrated circuit evaluates, based on selected target metrics, the updated neural network using inference input data values (block 216). As described earlier, if the selection criteria can be used to reduce the number of layers to inspect from 100 to 12, the number of nodes per layer to inspect from 20 to an average of 8, and the number of available numerical formats from 5 to an average of 3, then the number of combinations of representations of the weight values with less precision to evaluate significantly reduces.

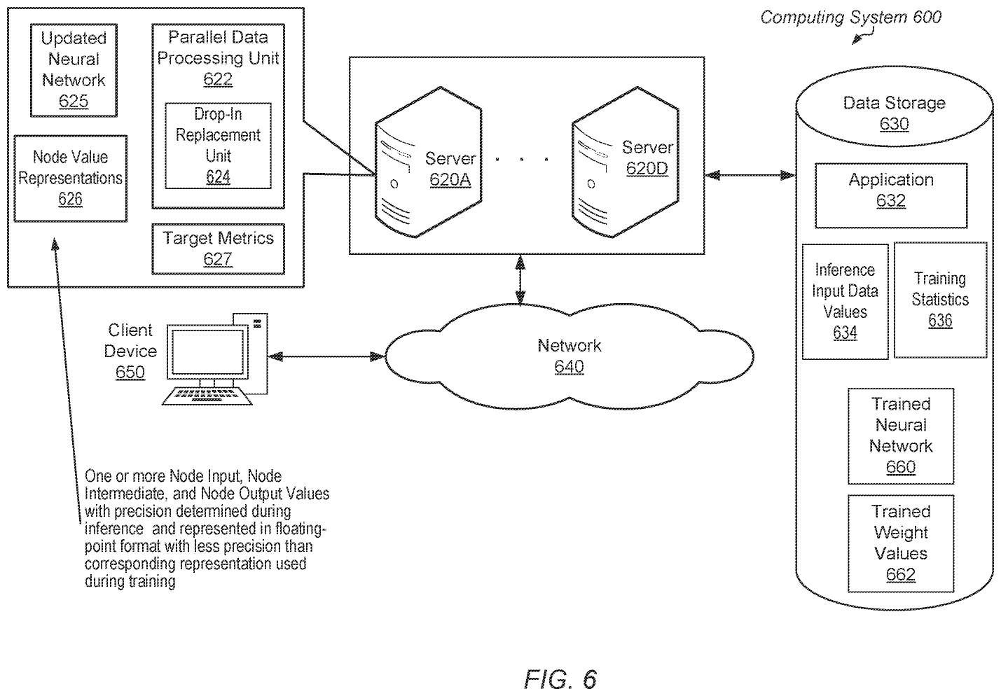

The above steps can reduce the number of iterations required to determine whether one or more of the node input values, node intermediate values, and node output values can be represented in different floating-point formats with less precision. During inference, further steps include determining whether target metrics are satisfied when using representations with less precision for trained weight values. Further details are provided in the description of method 500 (of FIG. 5) and computing system 600 (of FIG. 6).

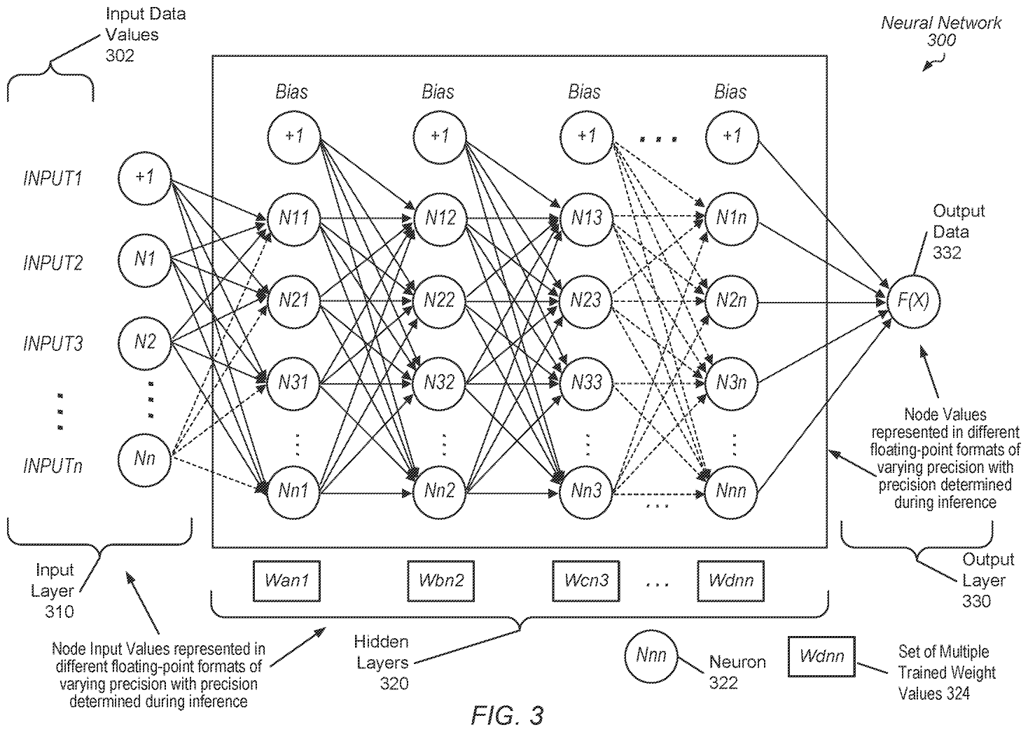

Referring to FIG. 3, a generalized diagram is shown of a trained neural network 300 that includes less computationally intensive nodes. As described earlier, examples of the trained neural network 300 are convolutional neural networks, recurrent neural networks, generative adversarial neural networks, and transformer neural networks. The trained neural network 300 classifies data in order to provide output data 332 that represents a prediction when given a set of inputs. To do so, the trained neural network 300 uses an input layer 310, one or more hidden layers 320, and an output layer 330. Each of the layers 310, 320 and 330 includes one or more neurons 322 (or nodes 322). Each of these neurons 322 receives input data. For example, the input layer 310 receives the input data values 302. For the one or more hidden layers 320 and the output layer 330, each of the neurons 322 receives input data as output data from one or more neurons 322 of a previous layer. These neurons 322 also receive one or more trained weight values 324 that are combined with corresponding input data.

It is noted that in some implementations, the trained neural network 300 includes only a single layer, rather than multiple layers. Such single-layer neural networks are capable of performing computations for at least edge computing applications. In other implementations, the trained neural network 300 has a relatively high number of hidden layers 320, and the trained neural network 300 is referred to as a deep neural network (DNN). Each of the neurons 322 of the trained neural network 300 combines a particular received input data value with a particular one of the trained weight values 324. In some implementations, the neurons 322 use matrix multiplication, such as General Matrix Multiplication (GEMM) operations, to perform the combining step. In other implementations, another type of operation is used in one or more of the neurons 322. Circuitry of a processor (not shown) performs the steps defined in each of the neurons 322 (or nodes 322) of the trained neural network 300. For example, the hardware, such as circuitry, of the processor performs at least the GEMM operations or other operations of the neurons 322. In some implementations, the circuitry of the processor is a data-parallel processing unit that includes multiple compute units, each with multiple lanes of execution that supports a data-parallel microarchitecture for processing workloads.

The bias (“Bias”) values represent a difference or shift of the prediction values provided by the neurons 322 from their intended values. A relatively high value for a particular bias indicates that the trained neural network 300 is assuming more than accurately predicting output values that should align with expected output values. A relatively low value for the particular bias indicates that the trained neural network 300 is accurately predicting output values that should align with expected output values. The trained weight values 324 indicate an amount of influence that a change of a corresponding input data value has on a change of the output data value of the particular neuron. A relatively low trained weight value indicates a change of a corresponding input data value provides little change of the output value of the particular neuron. In contrast, a relatively high trained weight value indicates a change of the corresponding input data value provides a significant change of the output value of the particular neuron.

The input data values 302, the bias values, the trained weight values 324, node intermediate values, and node output values used as node input values in a next, neighboring layer are represented in different floating-point formats of varying precision. Examples of the varying floating-point formats are one of a variety of 32-bit floating-point formats, one of a variety of 16-bit floating-point formats, one of a variety of 8-bit floating-point formats, and one of a variety of block floating-point formats. In some implementations, examples of the varying floating-point formats do not include any integer (fixed-point) formats. It is noted that there are no retraining steps performed on the trained neural network 300. Rather, quantization that uses only floating-point formats and no fixed-point formats occurs during inference. For example, the updating steps performed at time t4 on the trained neural network 120 (of FIG. 1) have been performed on the trained neural network 300. Therefore, one or more node input values, node intermediate values, and node output values are represented in floating-point formats with less precision than a floating-point format used for a corresponding value in a trained neural network.

The neurons 322 of the hidden layers 320, other than a last hidden layer, are not directly connected to the output layer 330. Each of the neurons 322 has a specified activation function such as a unit step function, which determines whether a corresponding neuron will be activated. An example of the activation function is the rectified linear unit (ReLU) activation function, which is a piecewise linear function used to transform a weighted sum of the received input values into the activation of a corresponding one of the neurons 322. When activated, the corresponding neuron generates a non-zero value, and when not activated, the corresponding neuron generates a zero value.

The activation function of a corresponding one of the neurons 322 receives the output of a matrix multiply and accumulate (MAC) operation or other operation. This MAC operation of a particular neuron of the neurons 322 combines each of the received multiple input data values with a corresponding one of the multiple trained weight values 324. The number of accumulations performed in the particular neuron before sending an output value to an activation function can be a relatively high number. For example, when each layer of the hidden layers 320 includes 20 neurons, the number of accumulations performed in the particular neuron is 20.

In some implementations, a designer uses an application programming interface (API) to specify multiple characterizing parameters used to generate the trained neural network 300 during training. Examples of these parameters are a number of input data values 302 for the input layer 310, an initial set of weight values for the weights 324, a number of layers of the hidden layer 320, a number of neurons 322 for each of the hidden layers 320, an indication of an activation function to use in each of the hidden layers 320, a loss function to use to measure the effectiveness of the mapping between the input data values 302 and the output data 332, and so on. In some implementations, different layers of the hidden layers 320 use different activation functions.

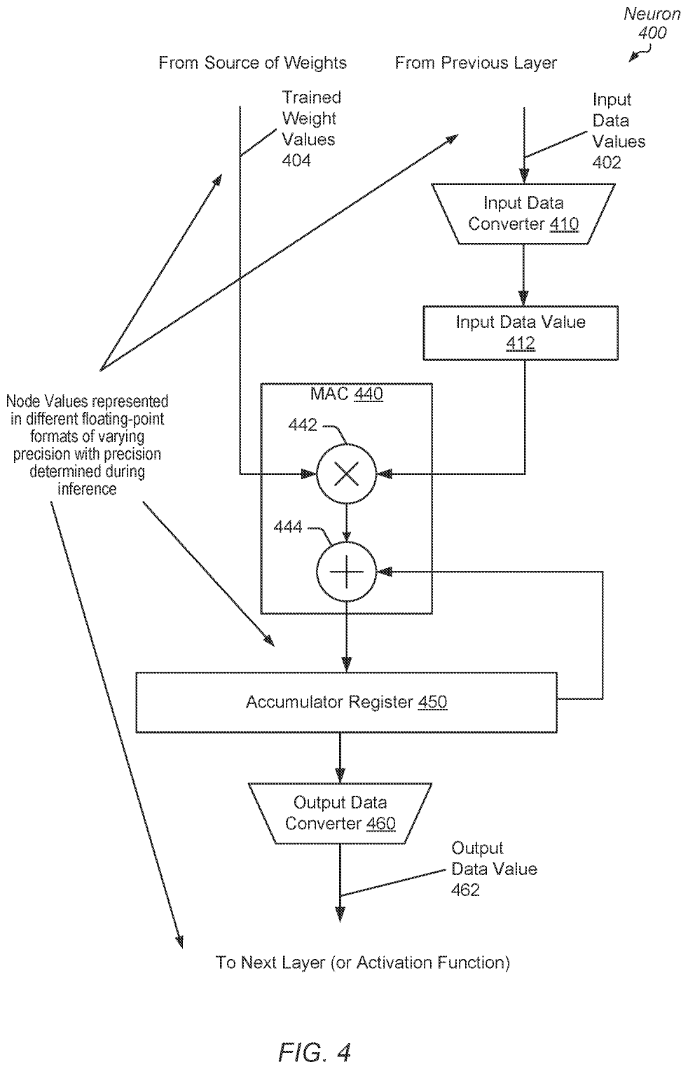

Turning now to FIG. 4, a generalized diagram is shown of a neuron 400 that includes less computationally intensive operations. As shown, the neuron 400 (or node 400) receives input data values 402 from a previous layer of a trained neural network, and receives trained weight values 404 from data storage of trained weights. The neuron 400 generates the output data value 462, which is sent to a next layer of the neural network. The hardware of the neuron 400 uses the circuitry of the components 410-460 to generate the output data value 452.

The input data converter 410 receives the input data values 402 from a previous layer of a neural network. In some implementations, the input data converter 410 performs the steps of one or more operations such as shifting, rounding, and saturating. The data conversion steps performed by each of the input data converter 410 and the output data converter 460 is based on the data size (bit width) of the input data value 412 used by the matrix multiply and accumulate (MAC) circuit 440 and the data size (bit width) of the accumulator register 450. Typically, the bit width of the accumulator register 450 is greater than the bit width of the input data value 412. Here, each of P and N is a positive, non-zero integer. At a later time when training has completed, the processor executing the neural network makes predictions, or the processor infers, output values based on received input values. This processing of the neural network performed by the hardware of the processor after training has completed is referred to as “inference.”

The node input values, node intermediate values, and node output values of the neuron 400 can be represented in different floating-point formats of varying precision with the precision being determined during inference, and the precision being less than a floating-point format of a corresponding variable in the trained neural network. Examples of the varying floating-point formats are one of a variety of 32-bit floating-point formats, one of a variety of 16-bit floating-point formats, one of a variety of 8-bit floating-point formats, and one of a variety of block floating-point formats. In some implementations, examples of the varying floating-point formats do not include any integer (fixed-point) formats.

The accumulator register 450 uses a data storage area that is implemented with one of a variety of data storage circuits such as flip-flop circuits, a random-access memory (RAM), a content addressable memory (CAM), a set of registers, a first-in-first-out (FIFO) buffer, or other. In an implementation, one or more node intermediate results generated by the neuron 400 are stored in local data storage that is not shown for ease of illustration. In some implementations, the output data value 462 is sent to an activation function circuit, and the output of the activation function circuit sends its output to the next layer of the neural network.

The matrix multiply and accumulate (MAC) circuit 440 uses the multiplier 442 to multiply a received input data value 412 and a received trained weight value 404. The MAC circuit 440 also uses the adder 444 to sum the product received from the multiplier 442 with products previously generated using other values of the input data value 412 and the trained weight value 404. For example, the neuron 400 receives a corresponding one of the input data values 402 from each of the neurons in a previous layer of the neural network. Each of these input data values 402 has a corresponding one of the trained weight values 404. The accumulator register stores the current output from the MAC 440, and this stored value is also returned to the MAC 440 to be summed with a next multiplication result from the multiplier 442. The number of accumulations performed in the neuron 400 before sending an output value to an activation function can be a relatively high number. This number of accumulations is equal to the number of neurons in the previous layer of the neural network.

Referring to FIG. 5, a generalized block diagram is shown of a method 500 for efficiently creating less computationally intensive nodes for a neural network. Circuitry of one of a variety of types of an integrated circuit performs steps to reduce a number of iterations to use for updating a representation of one or more weight values of a trained neural network representations with less precision. The integrated circuit generates a first set of one or more output values with a trained neural network during inference using trained weight values and inference input data values (block 502).

The integrated circuit selects one or more target metrics that evaluate behavior of the trained neural network during inference (block 504). The target metrics are used to determine whether any updated trained weight values are retained and then used as permanent replacements of the corresponding original trained weight values in updated trained weight values. The updated trained weight values use updated floating-point formats as updated representations that have less precision than floating-point formats used to represent corresponding original trained weight values. An example of the target metrics is a limit on an amount of data storage required for storing the trained weight values of the trained neural network. Another example of the target metrics is a performance threshold that defines a minimum number of inferences per unit time.

Another example of the target metrics is an accuracy threshold that defines a minimum of an absolute value of a difference between the output values generated during inference by the trained neural network using the original trained weight values and output values generated during inference by an updated neural network using the one or more updated trained weight values. The accuracy threshold can be indicated as a ratio and transformed into a percentage. An example of the accuracy threshold is 99.7%. Another example of the target metrics is a minimum number of trained weight values that have been updated. The target metrics can also include user input. The user can provide input at a keyboard or other peripheral device, or the user can generate a file that is accessed by the integrated circuit to determine the target metrics.

The integrated circuit selects one or more criteria to use for updating, during inference, the representations of one or more of the node input values, node intermediate values, and node output values of the trained neural network to representations with less precision (block 506). Examples of the criteria are the same as the examples described earlier regarding method 200 (of FIG. 2). Based on the one or more criteria, the integrated circuit selects one or more of the node input values, node intermediate values, and node output values of the trained neural network and updates the representations of these values to floating-point numerical formats with less precision (block 508). The integrated circuit generates a second set of one or more output values with the updated trained neural network during inference using the selected one or more node input values, node intermediate values, and node output values that use a representation with less precision (block 510).

The integrated circuit compares the first set and the second set of one or more output values in addition to comparing behavior of the trained neural network when generating these output values (block 512). The integrated circuit performs these comparisons to determine which of the specified target metrics are satisfied. If the integrated circuit determines that the target metrics have not been satisfied (“no” branch of the conditional block 514), then control flow of method 500 returns to block 504 where the integrated circuit selects one or more target metrics that evaluate behavior of the trained neural network during inference.

In some implementations, the one or more target metrics used for evaluating the behavior of the trained neural network are not changed. Additionally, the criteria selected in block 506 are not changed. However, in other implementations, one or more of the target metrics and the criteria are changed for one or more particular layers. Therefore, the target metrics and the criteria can be specified on a layer basis, rather than on a basis of the entire trained neural network.

If the integrated circuit determines that the target metrics have been satisfied (“yes” branch of the conditional block 514), then the integrated circuit inserts, in the updated trained neural network, the representations with less precision (block 516). In some implementations, the one or more output values being compared are generated by an intermediate layer of the hidden layers of the updated trained neural network, rather than the output layer. Therefore, the steps performed for block 512 and conditional block 514 are performed for this intermediate layer. In an implementation, even if the specified target metrics are met, rather than replace one or more representations with less precision of one or more node input values, node intermediate values, and node output values as done in block 516, these values are stored in temporary data storage and control flow of method 500 returns to block 504. Replacement is performed if the output layer is reached during inference and the target metrics are satisfied.

As described earlier, the target metrics and the criteria can be specified based on a count of layers that have been executed. Therefore, for layer 20 of 100 layers of the updated trained neural network, the target metrics and the criteria can be specified based on the execution of layers 1 to 20. Additionally, other target metrics and the criteria can be specified for layer 20 alone. If layers 5-10, 15 and 20 are the layers selected to have target metrics monitored on a layer basis and be candidate layers for having one or more node input values, node intermediate values, and node output values change representation to a representation with less precision, a count of layers that have been monitored is seven layers when layer 20 has been executed. In such a case, layers 1-4, 11-14 and 16-19 are not candidate layers for having one or more trained weight values change representation with less precision. However, these layers are still executed and used to provide execution measurements for layers 5-10, 15 and 20.

Even if layer 20 satisfies specified target metrics for only layer 20, and a count of layers that have satisfied respective target metrics meets a threshold (such as a count threshold of 4 layers of the 7 total layers when layer 20 is executed), the specified target metrics for the combination of layers 1-20 or for the combination of layers 5-10, 15 and 20 can still fail to be satisfied. As a result, in some implementations, the integrated circuit ends the inference. After ending the inference, in an implementation, control flow of method 500 returns to block 504, and execution of a new inference begins at the input layer of the trained neural network.

The integrated circuit can also store results and/or statistics of the abandoned inference in a log file in a specified data storage area. In some implementations, at block 506, using the one or more criteria, the integrated circuit determines whether one or more layers of the updated trained neural network have one or more trained weight values replaced with a value of zero. Zeroing one or more trained weight values introduces sparsity in the trained neural network, and corresponding nodes can skip computation.

Performing the steps of the previous method 200 (of FIG. 2) reduces the high number of iterations seeking to change the representation of a significant number of the node input values, node intermediate values, and node output values. Performing the steps of method 500 also reduces the high number of iterations while also determining whether to continue inference and whether to change the representation of a significant number of the node input values, node intermediate values, and node output values to a representation with less precision. Performing the steps of methods 200 and 500 can provide an accuracy near the accuracy of the original trained neural network while also changing the representation of some of the trained weight values to floating-point formats with less precision. In addition, the selection of the target metrics in block 506 directed to performance makes it possible to change the representation of a significant number of the node input values, node intermediate values, and node output values while also providing a performance level near the performance level of the original trained neural network. In an implementation, the performance level defines a number of inferences per unit time.

Performing the steps of methods 200 and 500 also maintains representation of the node input values, node intermediate values, and node output values in a floating-point format with no representation in an integer (fixed-point) format. Therefore, the node input values, node intermediate values, and node output values provide a wider range of values than a range that can be achieved with the integer (fixed-point) format. In addition, the node input values, node intermediate values, and node output values do not require range analysis and scaling that is performed for weight value replacement operations during Post Training Quantization (PTQ). In addition, no retraining is performed. The input values received by the training neural network are inference input data values, rather than training input values.

Turning now to FIG. 6, a generalized diagram is shown of a computing system 600. In the illustrated implementation, the computing system 600 includes the client computing device 650, a network 640, the servers 620A-620D, and the data storage 630. The data storage 630 includes at least a copy of a trained neural network 660, inference input data values 634, training statistics 636, and trained weight values 662. As shown, the server 620A includes a data-parallel processing unit 622 with circuitry that performs the steps of a drop-in replacement unit 624.

The node value representations 626 include floating-point formats selected during inference for one or more node input values, node intermediate values, and node output values. The node value representations 626 have less precision than corresponding floating-point formats used during training. To select the node value representations 626, the drop-in replacement unit 624 replaces floating-point formats of one or more node input values, node intermediate values, and node output values of a copy of the trained neural network 660 with other floating-point formats with less precision. In an example, the drop-in replacement unit 624 replaces representation of a particular weight value of a copy of the trained weight values 662. In an implementation, the particular weight value is represented in a 32-bit floating-point format with a mantissa of 24 bits and an exponent of 8 bits. The particular weight value is used in layer 30 of 100 layers of the trained neural network 660, and node 6 of 20 nodes of layer 30. The particular weight value is a ninth weight value from node 9 of the previous layer 29 used in node 6 of layer 30. The drop-in replacement unit 624 replaces the representation of this particular weight value with a representation that has less precision such as a 16-bit floating-point format with a mantissa of 10 bits and an exponent of 6 bits. There are no retraining steps performed on the trained neural network 660. Rather, quantization that uses only floating-point formats with less precision and no fixed-point formats occurs during inference.

Although the above example includes replacing representation of the single particular weight value, in various implementations, the drop-in replacement unit 624 replaces the representation of any number of node input values, node intermediate values, and node output values of the trained neural network 660. When considering the number of available floating-point formats from which to select and iterate through, the number of combinations of representations of the node input values, node intermediate values, and node output values to use in iterations during inference of the trained neural network 660 can significantly increase. To reduce this number of combinations of representations, the drop-in replacement unit 624 uses selection criteria to reduce the number of layers and the number of nodes within a layer to inspect. The selection criteria can also be used to reduce the number of weight values per node to inspect. The selection criteria can also be used to reduce the number of available numerical formats from which to select to represent the trained weight values.

In some implementations, the server 620A uses another type of integrated circuit, rather than the data-parallel processing unit 622, to perform the steps of the drop-in replacement unit 624. Although a single client computing device 650 is shown, any number of client computing devices utilize an online business, such as application 632, through the network 640. The client device 650 includes hardware circuitry such as a processing unit for processing instructions of computer programs. Examples of the client device 650 are a laptop computer, a smartphone, a tablet computer, a desktop computer, or other. In some implementations, the client device 650 includes a network interface (not shown) supporting one or more communication protocols for data and message transfers through the network 640. The network 640 includes multiple switches, routers, cables, wireless transmitters and the Internet for transferring messages and data. Accordingly, the network interface of the client device 650 support at least the Hypertext Transfer Protocol (HTTP) for communication across the World Wide Web.

In some implementations, an organizational center (not shown) maintains the application 632. In addition to communicating with the client device 650 through the network 640, the organizational center also communicates with the data storage 630 for storing and retrieving data. Through user authentication, users access resources through the organizational center to update user profile information, access a history of purchases or other accessed content, and download content for purchase. The servers 620A-620D include a variety of server types such as database servers, computing servers, application servers, file servers, mail servers and so on. In various implementations, the servers 620A-620D and the client device 650 operate with a client-server architectural model.

In various implementations, the application 632 includes one or more of a neural network application programming interface (API) and a graphical user interface (GUI) that the designer at the client device 650 uses to specify multiple characterizing parameters of a neural network to train. Examples of these parameters are a number of input data values in the inference input values 634 to send to an input layer of the neural network 660 during inference, a number of hidden layers for the neural network 660, a number of nodes or neurons for each of the hidden layers, an indication of an activation function to use in each of the hidden layers, and so on. In addition, examples of these parameters are the multiple examples of the selection criteria and target metrics, such as target metrics 627, described earlier in the description of the design timeline 100 (of FIG. 1), and the methods 200 and 500 (of FIGS. 2 and 5). It is noted that the data storage 630 stores a copy of one or more of the components stored on the server 620A such as the updated neural network 625, the weight values 626, the target metrics 627, and any instructions of an algorithm that describes the drop-in replacement unit 624 that is executed by the circuitry of the data-parallel processing unit 622.

It is also possible and contemplated that rather have a user use a GUI to provide the characterizing parameters, the drop-in replacement unit 624 provides them. In some implementations, the drop-in replacement unit 624 accesses a file that stores one or more of the above examples of characterizing parameters. In an implementation, the drop-in replacement unit 624 also accesses the training statistics 636 collected during training of the trained neural network 660. The drop-in replacement unit 624 analyzes the training statistics 636 to determine which layers of the multiple layers of the trained neural network 660 affect performance of the trained neural network 660 more than other layers. The drop-in replacement unit 624 also analyzes the training statistics 636 to determine which floating-point formats affect performance of the trained neural network 660 more than other floating-point formats. The drop-in replacement unit 624 analyzes the training statistics 636 to determine which layers and which nodes have higher sensitivity to changes in representation of the trained weight values 662. The sensitivity can lead to significant changes in output values of a particular layer, rather than significantly change the output values of the output layer.

One or more of the drop-in replacement unit 624 and the user creates a sorted list of strategies to attempt for changing the representation of a number of the node input values, node intermediate values, and node output values of the trained neural network 660. Each strategy of the sorted list includes values for the characterizing parameters such as at least one or more of the selection criteria and specified target metrics as described earlier. Each strategy also identifies which layers to attempt changes to the representations, which nodes to attempt changes to the representations, and which available floating-point formats to use. Prioritizing and sorting the strategies is done by either the drop-in replacement unit 624 or the user, and these steps are based on a variety of sorting criteria. The sorting criteria can be included in the target metrics 627 or be criteria separate from the target metrics 627. Examples of these sorting criteria are the predicted performance levels, the number of layers above a sensitivity threshold, the type of neural network, the number of layers that can significantly affect performance, and so on. In some implementations, the drop-in replacement unit 624 runs inference on the trained neural network 660 using each of the strategies provided in the sorted list, and comparisons and analysis can follow. In other implementations, the drop-in replacement unit 624 runs inference on the trained neural network 660 and ends inference when a threshold number of strategies of the sorted list is reached that satisfy one or more of the target metrics 627.

During each of the runs of inference on the trained neural network 660 using the sorted list, when one of the drop-in replacement unit 624 and the user at the client device 650 initiates inference of the neural network 660 to be performed by one or more of the servers 620A-620D, the drop-in replacement unit 624 determines which ones of the node input values, node intermediate values, and node output values of the trained neural network 660 to represent in a different floating-point format with less precision. In various implementations, the hardware, such a circuitry, of the drop-in replacement unit 624 performs steps similar to the steps described earlier regarding the updating steps at time t4 in the design timeline 100 (of FIG. 1) and the steps of the methods 200 and 500 (of FIGS. 2 and 5). By doing so, and when at least one of the strategies provides results that satisfy one or more of the target metrics 627, the drop-in replacement unit 624 changes the representation of a number of the node input values, node intermediate values, and node output values to a representation with less precision. The drop-in replacement unit 624 generates the node value representations 626 and the updated neural network 625 that uses the weight values 626 while also providing a performance level near the performance level of the original trained neural network 660. Additionally, the drop-in replacement unit 624 generates the node value representations 626 and the updated neural network 625 that provide an accuracy level above an accuracy threshold specified by the target metrics 627.

The drop-in replacement unit 624 also reduces the high number of iterations seeking to change the representation of a significant number of the node input values, node intermediate values, and node output values of the trained neural network 660 to a floating-point format with less precision. As described earlier, the drop-in replacement unit 624 also provides the updated neural network 625 that uses the node value representations 626 with an accuracy near the accuracy of the original trained neural network 660 while also changing the representation of some of the node input values, node intermediate values, and node output values to floating-point formats with less precision. In some implementations, the node value representations 626 does not include an integer (fixed-point) format. Further, the drop-in replacement unit 624 changes the representation of the significant number of the node input values, node intermediate values, and node output values during inference with no retraining.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
select a first node value of a trained neural network represented in a first floating-point numerical format, based at least in part on one or more selection criteria;
generate a first output value with the trained neural network during inference using the first node value represented in a second floating-point numerical format different from the first floating-point numerical format; and
replace, in the trained neural network, the first floating-point numerical format with the second floating-point numerical format for the first node value, in response to one or more target metrics based on the first output value being satisfied.

2. The apparatus as recited in claim 1, wherein the second floating-point numerical format has less precision than the first floating-point numerical format.

3. The apparatus as recited in claim 1, wherein the circuitry is further configured to select a subset of a total number of layers of the trained neural network to update floating-point numerical formats of one or more node input values, node intermediate values, and node output values of the trained neural network, in response to a type of the trained neural network is included in the one or more selection criteria.

4. The apparatus as recited in claim 3, wherein the circuitry is further configured to select a subset of a total number of available floating-point numerical formats to use as the second floating-point numerical format, in response to a type of the trained neural network is included in the one or more selection criteria.

5. The apparatus as recited in claim 4, wherein the type of the trained neural network included in the one or more selection criteria comprises one or more of transformer neural networks, convolution neural networks, recurrent neural networks, and generative adversarial neural networks.

6. The apparatus as recited in claim 1, wherein the circuitry is further configured to select, as the one or more target metrics, an accuracy of the first output value compared to a second output value generated by the trained neural network using the first node value represented in the first floating-point numerical format.

7. The apparatus as recited in claim 1, wherein the circuitry is further configured to select, as the one or more target metrics, a first amount of data storage used to generate the first output value compared to a second amount of data storage used to generate a second output value by the trained neural network using the first node value represented in the first floating-point numerical format.

8. A method, comprising:
selecting, by circuitry of a processor, a first node value of a trained neural network represented in a first floating-point numerical format, based at least in part on one or more selection criteria;
generating, by the processor, a first output value with the trained neural network during inference using the first node value represented in a second floating-point numerical format different from the first floating-point numerical format; and
replacing, in the trained neural network by the processor, the first floating-point numerical format with the second floating-point numerical format for the first node value, in response to one or more target metrics based on the first output value being satisfied.

9. The method as recited in claim 8, wherein the second floating-point numerical format has less precision than the first floating-point numerical format.

10. The method as recited in claim 8, further comprising selecting, by the processor, a subset of a total number of layers of the trained neural network to update floating-point numerical formats of one or more node input values, node intermediate values, and node output values of the trained neural network, in response to a type of the trained neural network is included in the one or more selection criteria.

11. The method as recited in claim 10, further comprising selecting, by the processor, a subset of a total number of available floating-point numerical formats to use as the second floating-point numerical format, in response to a type of the trained neural network is included in the one or more selection criteria.

12. The method as recited in claim 11, wherein the type of the trained neural network included in the one or more selection criteria comprises one or more of transformers neural networks, convolution neural networks, recurrent neural networks, and generative adversarial neural networks.

13. The method as recited in claim 8, further comprising selecting, as the one or more target metrics by the processor, an accuracy of the first output value compared to a second output value generated by the trained neural network using the first node value represented in the first floating-point numerical format.

14. The method as recited in claim 8, further comprising selecting, as the one or more target metrics by the processor, a first amount of data storage used to generate the first output value compared to a second amount of data storage used to generate a second output value by the trained neural network using the first node value represented in the first floating-point numerical format.

15. A computing system comprising:
a memory comprising circuitry configured to store a plurality of weight values of a trained neural network;
a processor comprising circuitry configured to:
select a first node value of the plurality of weight values of the trained neural network represented in a first floating-point numerical format, based at least in part on one or more selection criteria;
generate a first output value with the trained neural network during inference using the first node value represented in a second floating-point numerical format different from the first floating-point numerical format; and
replace, in the trained neural network, the first floating-point numerical format with the second floating-point numerical format for the first node value, in response to one or more target metrics based on the first output value being satisfied.

16. The computing system as recited in claim 15, wherein the second floating-point numerical format has less precision than the first floating-point numerical format.

17. The computing system as recited in claim 15, wherein the processor is further configured to select a subset of a total number of layers of the trained neural network to update floating-point numerical formats of one or more node input values, node intermediate values, and node output values of the trained neural network, in response to a type of the trained neural network is included in the one or more selection criteria.

18. The computing system as recited in claim 17, wherein the processor is further configured to select a subset of a total number of available floating-point numerical formats to use as the second floating-point numerical format, in response to a type of the trained neural network is included in the one or more selection criteria.

19. The computing system as recited in claim 18, wherein the type of the trained neural network included in the one or more selection criteria comprises one or more of transformers neural networks, convolution neural networks, recurrent neural networks, and generative adversarial neural networks.

20. The computing system as recited in claim 15, wherein the processor is further configured to select, as the one or more target metrics, an accuracy of the first output value compared to a second output value generated by the trained neural network using the first node value represented in the first floating-point numerical format.
